(19) United States
(12) Patent Application Publication
(10) Pub. No.: US 2017/0229088 A1
(43) Pub. Date: Aug. 10, 2017

(54) LIQUID CRYSTAL DISPLAY DEVICE AND LIQUID CRYSTAL DISPLAY

(71) Applicant: Shenzhen China Star Optoelectronics Technology Co. Ltd., Shenzhen, Guangdong (CN)

(72) Inventors: Lei WANG, Shenxhen, Guangdong (CN); Ping-sheng KUO, Shenzhen, Guangdong (CN); Li ZHOU, Shenzhen, Guangdong (CN); Yu-yeh CHEN, Shenzhen, Guangdong (CN)

(73) Assignee: Shenzhen China Star Optoelectronics Technology Co. Ltd., Shenzhen, Guangdong (CN)

(21) Appl. No.: 14/905,249

(22) PCT Filed: Nov. 23, 2015
(86) PCT No.: PCT/CN2015/098413

§ 371 Date: Jan. 14, 2016

(30) Foreign Application Priority Data
Nov. 19, 2015 (CN) 201510799357.5

(51) Int. Cl. G09G 3/36

(52) U.S. Cl. CPC G09G 3/3696; G09G 3/3677; G09G 3/3688; G09G 2320/0233; G09G 2310/0289; G09G 2310/0202

(57) ABSTRACT

The present invention discloses a LCD device and a LCD. The LCD device includes: a power supply unit, a gate driver circuit, a source driver circuit and a plurality of data lines and scan lines that interlace mutually, the gate driver circuit includes a plurality of gate driver integrated circuits, the source driver circuit includes a plurality of source driver integrated circuits, the power supply unit is applied to generate a gate high voltage and a gate low voltage; the power supply unit transmits the gate high voltage to a plurality of gate driver integrated circuits by a plurality of first transmission routes, the power supply unit transmits the gate low voltage to a plurality of gate driver integrated circuits by a plurality of second transmission routes, the plurality of gate driver integrated circuits provide scanning signals to the plurality of scan lines in turn.

### CROSS REFERENCE

This application claims the priority of Chinese Patent Application No. 201510799357.5, entitled “Liquid crystal display device and liquid crystal display”, filed on Nov. 19, 2015, the disclosure of which is incorporated herein by reference in its entirety.

### FIELD OF THE INVENTION

The present invention relates to a liquid crystal field, and more particularly to a liquid crystal display device and a liquid crystal display.

### BACKGROUND OF THE INVENTION

Liquid crystal display devices are widely applied in various fields such as portable apparatus, household electronic products, space instruments and medical equipment.

A conventional liquid crystal display device can include a LCD panel, whereon a number of data lines and scan lines are interlaced mutually; a power supply unit, which is applied to provide sorts of drive voltage information, such as gate high voltage (VGH) signals, gate low voltage (VGL) signals, a common voltage (VCOM), source driving voltage signals, etc.; a gate driver circuit, which is applied to drive the number of scan lines; and a source driver circuit, which is applied to drive the number of data lines. The gate driver circuit includes a number of gate driver ICs, applied to receive VGH signals and VGL signals generated by the power supply unit, and offering scanning signals to the number of scan lines in turn, and the source driver circuit includes a number of source driver ICs, which are applied to provide source driving voltage signals to the corresponding data lines respectively.

However, as the gate driver ICs are distributed at different positions, resulting in different distances from the power supply unit to various gate driver ICs, hence impedance of routes from the power supply unit to various gate driver ICs is unequal, and intensities of VGH signals generated by the power supply unit to various gate driver ICs are different. VGL signals generated by the power supply unit are parallel. From a view of effects of the display, brightness of a liquid crystal display in different lines is uneven, called H-block.

### SUMMARY OF THE INVENTION

The technical issue that the embodiment of the present invention solves is to provide a liquid crystal display device and a liquid crystal display, which can avoid the appearance of H-block.

The present invention provides a liquid crystal display device, including:a power supply unit, a gate driver circuit, a source driver circuit and a plurality of data lines and scan lines that interlace mutually, the gate driver circuit includes a plurality of gate driver integrated circuits, the source driver circuit includes a plurality of source driver integrated circuits,the power supply unit is applied to generate a gate high voltage and a gate low voltage; the power supply unit transmits the gate high voltage to a plurality of gate driver integrated circuits by a plurality of first transmission routes, the power supply unit transmits the gate low voltage to a plurality of gate driver integrated circuits by a plurality of second transmission routes, the plurality of gate driver integrated circuits provide scanning signals to the plurality of scan lines in turn; the source driver circuit is applied to provide a corresponding source driver voltage signals to the plurality of data lines; resistance values of the plurality of first transmission routes are the same, resistance values of the plurality of second transmission routes are the same, the first transmission route includes a first resistor and a first transmission route, the second transmission route includes a second resistor and a second transmission route, resistance values of the first transmission route and the second transmission route are the same.

Optionally, the first resistor and the second resistor are both adjustable resistors.

The invention provides a liquid crystal display device, including: a power supply unit, a gate driver circuit, a source driver circuit and a plurality of data lines and scan lines that interlace mutually, the gate driver circuit includes a plurality of gate driver integrated circuits, the source driver circuit includes a plurality of source driver integrated circuits, the power supply unit is applied to generate a gate high voltage and a gate low voltage; the power supply unit transmits the gate high voltage to a plurality of gate driver integrated circuits by a plurality of first transmission routes, the power supply unit transmits the gate low voltage to a plurality of gate driver integrated circuits by a plurality of second transmission routes, the plurality of gate driver integrated circuits provide scanning signals to the plurality of scan lines in turn; the source driver circuit is applied to provide a corresponding source driver voltage signals to the plurality of data lines; resistance values of the plurality of first transmission routes are the same, resistance values of the plurality of second transmission routes are the same.

Optionally, the first transmission route is a first transmission line, the second transmission route is a second transmission line.

Optionally,the first transmission route includes a first resistor and a first transmission line, the second transmission route includes a second resistor and a second transmission line.

Optionally,the first resistor and the second resistor are both adjustable resistors.

Optionally, resistance values of the first transmission route and the second transmission route are the same.

The present invention further provides a liquid crystal display, including a liquid crystal display device and a baseplate, the liquid crystal display device includes: a power supply unit, a gate driver circuit, a source driver circuit and a plurality of data lines and scan lines that interlace mutually, the gate driver circuit includes a plurality of gate driver integrated circuits, the source driver circuit includes a plurality of source driver integrated circuits, the power supply unit is applied to generate a gate high voltage and a gate low voltage; the power supply unit transmits the gate high voltage to a plurality of gate driver integrated circuits by a plurality of first transmission routes, the power supply unit transmits the gate low voltage to a plurality of gate driver integrated circuits by a plurality of second transmission routes, the plurality of gate driver integrated circuits provide scanning signals to the plurality of scan lines in turn; the source driver circuit is applied to provide a corresponding source driver voltage signals to the plurality of data lines; resistance values of the plurality of first transmission routes are the same, resistance values of the plurality of second transmission routes are the same.

Optionally, the first transmission route is a first transmission line, the second transmission route is a second transmission line.

Optionally, the first transmission route includes a first resistor and a first transmission line, the second transmission route includes a second resistor and a second transmission line.

Optionally, the first resistor and the second resistor are both adjustable resistors.

Optionally, resistance values of the first transmission route and the second transmission route are the same.

According to embodiments of the invention, resistance values of a plurality of first transmission routes are the same, resistance values of a plurality of second transmission routes are the same, leading to voltage values when VGH signals and VGL signals generated by the power supply unit transmitting to a plurality of gate driver ICs are the same, which can avoid H-block.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a circuit diagram of a liquid crystal display device according to an embodiment of the present invention;

FIG. 2 is a circuit diagram of another liquid crystal display device according to an embodiment of the present invention.

### DETAILED DESCRIPTION OF PREFERRED EMBODIMENTS

Embodiments of the present invention are described in detail with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

Specifically, the terminologies in the embodiments of the present invention are merely for describing the purpose of the certain embodiment, but not to limit the invention. Examples and the appended claims be implemented in the present invention requires the use of the singular form of the book “an”, “the” and “the” are intended to include most forms unless the context clearly dictates otherwise. It should also be understood that the terminology used herein that “and/or” means and includes any or all possible combinations of one or more of the associated listed items.

The present invention provides a liquid crystal display device. The device includes: a liquid crystal display panel, a source printed circuit board, source strip embedment carriers, a source driver circuit, a gate driver circuit and a power supply unit. The liquid crystal display panel from top to bottom includes: an upper substrate, a color filter film and a bottom substrate, as well as a liquid crystal material layer disposed between the upper substrate and the bottom substrate. The bottom substrate is also called a thin film transistor substrate or an array substrate, whereon a plurality of data lines and scan lines are interlaced mutually. The source driver circuit can include a plurality of source driver integrated circuits, embedded respectively in source strip embedment carriers disposed between one side of the liquid crystal display panel and the source printed circuit board, and the gate driver circuit includes a number of gate driver ICs disposed on one side of the liquid crystal panel by glass attachment technology. In reality, gate driver ICs in the gate driver circuit can also be embedded in a number of gate strip embedment carriers adjacent to the other side of the LCD panel respectively.

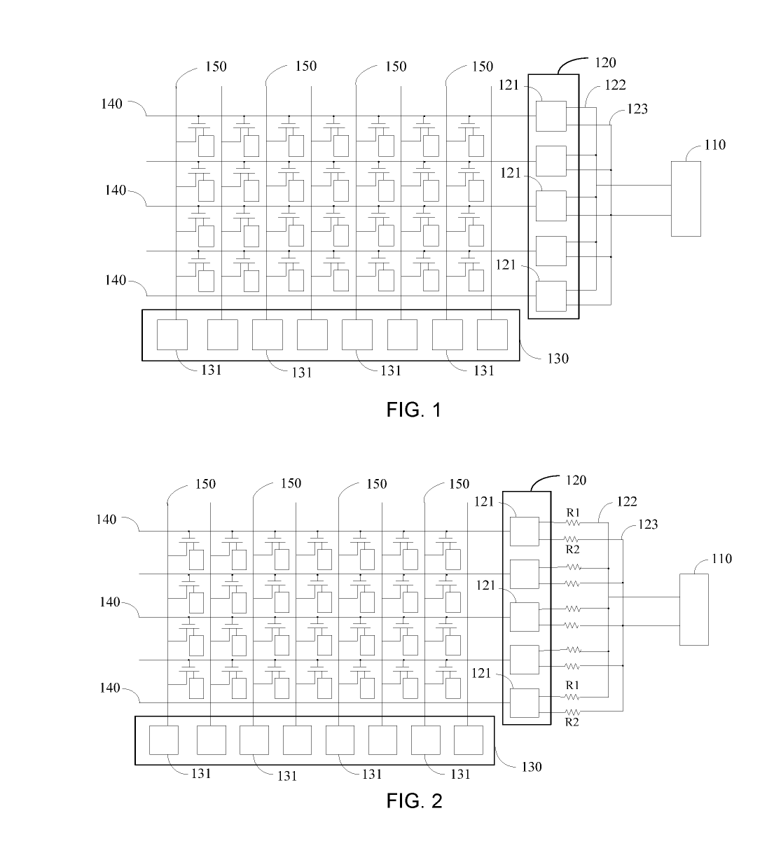

As the invention merely relates to electrical connection of a LCD device, for convenience of expression and comprehension, FIG. 1 only describes electrical connection of relating components in a LCD device. As shown in FIG. 1, a LCD device includes: a power supply unit 110, a gate driver circuit 120, a source driver circuit 130 and a plurality of data lines 140 and scan lines 150 that interlace mutually, the gate driver circuit 120 includes a plurality of gate driver integrated circuits 121, applied to drive the corresponding scan lines 150, the source driver circuit 130 includes a plurality of source driver integrated circuits 131, applied to drive the corresponding data lines 140.

The power supply unit 110 is applied to generate sorts of drive voltage information to drive a LCD panel, such as a gate high voltage, a gate low voltage, a common voltage, a source driving voltage, a grounding voltage, etc. The gate high voltage generated by the power supply unit 110 is transmitted to the gate driver circuit 120 by a first transmission route 121, the gate low voltage generated by the power supply unit 110 is transmitted to the gate driver circuit 120 by a second transmission route 121.The gate high voltages generated by the power supply unit 110 are transmitted to a number of gate driver ICs 122 by a number of first transmission routes 121, the gate low voltages generated by the power supply unit 110 are transmitted to a number of gate driver ICs 122 by a number of second transmission routes 121. For instance, a first transmission route 121 transmits a gate high voltage generated by the power supply unit 110 to a gate driver IC 122, a second transmission route transmits a gate low voltage generated by the power supply unit 110 to a gate driver IC 122. Resistance values of a number of the first transmission routes are designed to be the same, resistance values of a number of the second transmission routes are designed to be the same.

In an embodiment, the first transmission route is a first transmission line, and the first transmission lines are designed to have the same lengths and radiuses, which can ensure resistance values of a number of the first transmission routes are equal. Although distances from the power supply unit 110 to various gate driver ICs 122 are different, a circuitous route can be designed to a first transmission route with shorter distance from the power supply unit 110 to various gate driver IC 122 to guarantee equal lengths of the first transmission lines. The second transmission route is a second transmission line, and the second transmission lines are designed to have the same lengths and radiuses, which can ensure resistance values of a number of the second transmission routes are equal. Although distances from the power supply unit 110 to various gate driver ICs 122 are different, a circuitous route can be designed to a second transmission route with shorter distance from the power supply unit 110 to various gate driver IC 122 to guarantee equal lengths of the second transmission lines.

Otherwise, lengths of the first transmission route are various, a width of a first transmission line with shorter distance from the power supply unit 110 to a gate driver IC 122 can be designed to be narrower, a width of a first transmission line with longer distance from the power supply unit 110 to a gate driver IC 122 can be designed to be wider, which can ensure resistance values of the first transmission routes are equal. Similarly, a width of a second transmission line with shorter distance from the power supply unit 110 to a gate driver IC 122 can be designed to be narrower, a width of a second transmission line with longer distance from the power supply unit 110 to a gate driver IC 122 can be designed to be wider, which can ensure resistance values of the second transmission routes are the same.

In another embodiment, a first transmission route includes a first resistor R1 and a first transmission line 122, the first resistor R1 and the first transmission line 122 are series connected, resistance value of the first resistor R1 of the each of the first transmission routes and a sum of resistance values of the first transmission lines 122 are designed to be equal. Similarly, a second transmission route includes a second resistor R2 and a second transmission line 123, the second resistor R2 and the second transmission line 123 are series connected, resistance value of the second resistor R2 of the each of the second transmission routes and a sum of resistance values of the second transmission lines 123 are designed to be equal. Optionally, the first resistor R1 and the second resistor R2 can be set to be adjustable resistors, which can adjust resistance values of the first transmission route and the second transmission route.

Resistance values of the first transmission route and the second transmission route can be set equally, reducing H-Block phenomenon.

According to embodiments of the invention, resistance values of a plurality of first transmission routes are the same, resistance values of a plurality of second transmission routes are the same, leading to voltage values when VGH signals and VGL signals generated by the power supply unit transmitting to a plurality of gate driver ICs are the same, which can avoid H-block.

The invention also provides a LCD, including a liquid crystal display device and a baseplate, the liquid crystal display device can be referred to FIG. 1, FIG. 2 and relating description, more information is glossed over.

It is understandable in practical to the person who is skilled in the art that all or portion of the processes in the method according to the aforesaid embodiment can be accomplished with the computer program to instruct the related hardware. The program can be stored in a readable storage medium if the computer. As the program is executed, the processes of the embodiments in the aforesaid respective methods can be included. The storage medium can be a diskette, an optical disc, a Read-Only Memory (ROM) or a Random Access Memory (RAM).

Above are embodiments of the present invention, which does not limit the scope of the present invention. Any modifications, equivalent replacements or improvements within the spirit and principles of the embodiment described above should be covered by the protected scope of the invention.

What is claimed is:

1. A liquid crystal display device, wherein it comprises a power supply unit, a gate driver circuit, a source driver circuit and a plurality of data lines and scan lines that interlace mutually, the gate driver circuit comprises a plurality of gate driver integrated circuits, the source driver circuit comprises a plurality of source driver integrated circuits,
the power supply unit is applied to generate a gate high voltage and a gate low voltage; the power supply unit transmits the gate high voltage to a plurality of gate driver integrated circuits by a plurality of first transmission routes, the power supply unit transmits the gate low voltage to a plurality of gate driver integrated circuits by a plurality of second transmission routes, the plurality of gate driver integrated circuits provide scanning signals to the plurality of scan lines in turn; the source driver circuit is applied to provide a corresponding source driver voltage signals to the plurality of data lines;
resistance values of the plurality of first transmission routes are the same, resistance values of the plurality of second transmission routes are the same, the first transmission route comprises a first resistor and a first transmission route, the second transmission route comprises a second resistor and a second transmission route, resistance values of the first transmission route and the second transmission route are the same.

2. The device according to claim 1, wherein the first resistor and the second resistor are both adjustable resistors.

3. A liquid crystal display device, wherein it comprises a power supply unit, a gate driver circuit, a source driver circuit and a plurality of data lines and scan lines that interlace mutually, the gate driver circuit comprises a plurality of gate driver integrated circuits, the source driver circuit comprises a plurality of source driver integrated circuits,
the power supply unit is applied to generate a gate high voltage and a gate low voltage; the power supply unit transmits the gate high voltage to a plurality of gate driver integrated circuits by a plurality of first transmission routes, the power supply unit transmits the gate low voltage to a plurality of gate driver integrated circuits by a plurality of second transmission routes, the plurality of gate driver integrated circuits provide scanning signals to the plurality of scan lines in turn; the source driver circuit is applied to provide a corresponding source driver voltage signals to the plurality of data lines;
resistance values of the plurality of first transmission routes are the same, resistance values of the plurality of second transmission routes are the same.

4. The device according to claim 3, wherein the first transmission route is a first transmission line, the second transmission route is a second transmission line.

5. The device according to claim 3, wherein the first transmission route comprises a first resistor and a first transmission line, the second transmission route comprises a second resistor and a second transmission line.

6. The device according to claim 5, wherein the first resistor and the second resistor are both adjustable resistors.

7. The device according to claim 3, wherein resistance values of the first transmission route and the second transmission route are the same.

8. A liquid crystal display, wherein it comprises a liquid crystal display device and a baseplate, the liquid crystal display device comprises: a power supply unit, a gate driver circuit, a source driver circuit and a plurality of data lines and scan lines that interlace mutually, the gate driver circuit comprises a plurality of gate driver integrated circuits, the source driver circuit comprises a plurality of source driver integrated circuits,
the power supply unit is applied to generate a gate high voltage and a gate low voltage; the power supply unit transmits the gate high voltage to a plurality of gate driver integrated circuits by a plurality of first transmission routes, the power supply unit transmits the gate low voltage to a plurality of gate driver integrated circuits by a plurality of second transmission routes, the plurality of gate driver integrated circuits provide scanning signals to the plurality of scan lines in turn; the source driver circuit is applied to provide a corresponding source driver voltage signals to the plurality of data lines;
resistance values of the plurality of first transmission routes are the same, resistance values of the plurality of second transmission routes are the same.

9. The liquid crystal display according to claim 8, wherein the first transmission route is a first transmission line, the second transmission route is a second transmission line.

10. The liquid crystal display according to claim 9, wherein the first transmission route comprises a first resistor and a first transmission line, the second transmission route comprises a second resistor and a second transmission line.

11. The liquid crystal display according to claim 10, wherein the first resistor and the second resistor are both adjustable resistors.

12. The liquid crystal display according to claim 8, wherein resistance values of the first transmission route and the second transmission route are the same.
